(19) United States
(12) Patent Application Publication
(10) Pub. No.: US 2021/0264756 A1
(43) Pub. Date: Aug. 26, 2021

(54) IN-STORE AUTOMATIC SELF-CHECKOUT

(71) Applicant: Walmart Apollo, LLC, Bentonville, AR (US)

(72) Inventor: Nilabh Sagar, Bangalore (IN)

(21) Appl. No.: 17/177,911

(22) Filed: Feb. 17, 2021

Related U.S. Application Data
(60) Provisional application No. 62/977,926, filed on Feb. 18, 2020.

(51) Int. Cl. G08B 13/24; G08B 13/14; G07G 1/00; G06Q 30/06; G06Q 20/10; H04W 4/35; H04W 4/80

(52) U.S. Cl. CPC G08B 13/246; G08B 13/2462; G08B 13/1436; G08B 13/2417; H04W 4/80; G06Q 30/0633; G06Q 20/102; H04W 4/35; G07G 1/009

(57) ABSTRACT

In some embodiments, apparatuses and methods are provided herein useful to perform an automatic self-checkout in a store. In some embodiments, an automatic in-store self-checkout system comprises products associated with active RFID tags affixed thereto and a shopping cart comprising a computer readable identifier, a magnetic element, and a shopping cart RFID reader. The system further comprises RFID readers and emitters positioned about the store, and a checkout zone comprising checkout RFID readers and emitters therein. The system electronically links the shopping cart to an online cart associated with a customer using the cart's readable identifier, adds and removes products to the online cart using the active RFID product tags and shopping cart RFID reader, and facilitates an automatic electronic payment transaction for the products in the cart as the customer passes through the checkout zone with their cart.

### CROSS-REFERENCE TO RELATED APPLICATIONS

This application claims the benefit of U.S. Provisional Application No. 62/977,926, filed Feb. 18, 2020, which is incorporated herein by reference in its entirety.

### TECHNICAL FIELD

This invention relates generally to automatic self-checkout in a store and, in particular, the use of radio frequency identification (RFID) signals to facilitate automatic self-checkout in a store.

### BACKGROUND

Retail stores continue to be a primary way in which people purchase products for consumption and use. Customers enter the store and often push shopping carts while collecting products the customer intends to purchase. The traditional barcode checkout system requires the scanning of each item to be purchased by a cashier or by the customer, which may be time-consuming and require human resources that may be deployed for other purposes. Streamlining customer transactions at point of sale stations may increase customer satisfactions and store efficiencies. There continues to be a need to provide a positive shopping experience for customers while also increasing store efficiencies.

### BRIEF DESCRIPTION OF THE DRAWINGS

Disclosed herein are embodiments of systems, apparatuses and methods pertaining to performing an automatic self-checkout in a store. This description includes drawings, wherein:

FIG. 1 illustrates a simplified block diagram of an exemplary retail store RFID-based automatic self-checkout system, in accordance with some embodiments.

FIG. 2 illustrates a simplified view of an exemplary shopping cart in front of a product support device, which houses products having an active RFID tag attached thereto, in accordance with some embodiments.

FIG. 3 illustrates a simplified overhead view of at least a portion of an exemplary retail store that includes RFID emitters and readers positioned therein, in accordance with some embodiments.

FIG. 4 illustrates a simplified overhead view of an automatic checkout zone in a retail store, in accordance with some embodiments.

FIG. 5 illustrates a simplified view of a shopping cart in an automatic checkout zone in a retail store, in accordance with some embodiments, in accordance with some embodiments.

FIG. 6 illustrates a simplified flow diagram of an exemplary automatic self-checkout process in a store based on RFID signals, in accordance with some embodiments.

FIG. 7 illustrates an exemplary system for use in implementing methods, techniques, devices, apparatuses, systems, servers, and sources to perform an automatically self-checkout in a store based on RFID signals, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to perform an automatic self-checkout in a retail store. The retail store includes products throughout a sales floor that are to be sold and/or distributed to customers. The store may be any size or format and may include products from one or more merchants. For example, the store may be a single store operated by one merchant, a chain of two or more stores operated by one entity, or may be a collection of stores covering multiple merchants. The products for purchase in the store are equipped with active radio frequency identification (RFID) tags affixed thereto. The active product RFID tags are self-powered, enabling the RFID tags to emit a signal and, as such, are distinguished from passive RFID tags, which do not emit a signal. In some approaches, the active RFID tags are configured to communicate using a Bluetooth-compatible low energy signal. The active RFID tags include an onboard battery and may configured to be activated by movement. In some embodiments, the active RFID tags may include a 3-axis gyroscope, a 3-axis accelerometer, and 3-axis magnetometer.

The store includes a plurality of store RFID emitters positioned about the store, which emit signals that are detected by RFID readers associated with compatible shopping carts in the store. The store also includes a plurality of store RFID readers positioned about the store, which are configured to receive signals from the plurality of active RFID tags associated with the products in the store.

Further included are one or more shopping carts, each including an RFID reader configured to detect products being added to and removed from the shopping cart based on each product's associated RFID tag. The shopping cart RFID reader may also be configured to detect signals emitted from the store RFID emitters, which may be used to track the location of the shopping cart. Each shopping cart also has a unique computer readable identifier affixed thereto. The unique identifier is configured to be read by a customer's portable electronic device (e.g., a mobile device such as a smartphone) and electronically identifies the particular shopping cart. When the customer selects a particular shopping cart upon entering the store, the customer scans or otherwise electronically reads the computer readable identifier with their portable electronic device, which links the physical shopping cart to the customer's online shopping cart.

Further included is a control circuit, which is configured to communicate with the various RFID readers associated with the system, among other components. The control circuit is also configured to electronically link the physical shopping cart to the online shopping cart associated with the customer when the computer readable identifier is read by the customer's portable electronic device.

As the customer proceeds throughout the store with their shopping cart, the customer selects products for purchase and places the selected products in the cart. Movement of the product into the cart activates the active RFID tag associated with the product, causing the active RFID tag to emit a signal that is detected by the shopping cart RFID reader. In some approaches, the shopping cart further includes a magnetic element and the active RFID tag detects the shopping cart's magnetic element and causes the active RFID tag to transmit a first signal, which is received by the shopping cart RFID reader. The shopping cart RFID reader then adds to the first signal a marker associated with the shopping cart RFID reader and transmits the marked first signal to the control circuit indicating that the selected product has been placed in the shopping cart. The control circuit is configured to receive the signal from the shopping cart RFID reader indicating that a particular product has been placed in the shopping cart, prompting the control circuit to electronically add the selected product to the customer's online shopping cart.

Conversely, in some embodiments, when a product is removed from the shopping cart, the active RFID tag associated with the product detects the movement, which reactivates the RFID tag, and when the active RFID tag no longer detects the shopping cart's magnetic element, the active RFID tag transmits a second signal, which is received by the shopping cart RFID reader. The shopping cart RFID reader then adds to the second signal the marker associated with the shopping cart RFID reader and transmits the marked second signal to the control circuit indicating that the selected product has been removed from the shopping cart. This prompts the control circuit to electronically remove the selected product to the customer's online shopping cart.

In some embodiments, the control circuit may be configured to determine a location of the shopping cart in the store based on signals received by the shopping cart RFID reader from the plurality of store RFID emitters positioned about the store, which the shopping cart RFID reader transmits to the control circuit. Similarly, in some embodiments, the control circuit may be configured to determine a location of the active RFID tags associated with selected products based on signals from the active RFID tags received by the store RFID readers, which the active RFID tags transmit to the control circuit.

When the customer has finished shopping, the customer proceeds to a checkout zone positioned near an exit of the store. The checkout zone includes one or more checkout RFID emitters and, in some embodiments, one or more checkout RFID readers. When the customer enters the checkout zone, the shopping cart RFID reader receives a signal from a checkout RFID emitter indicating that the shopping cart has entered the checkout zone, which the shopping cart RFID reader transmits to the control circuit. The control circuit may then facilitate an automatic payment transaction enabling the customer to pay for the products in the online shopping cart, which correspond to the products in their physical shopping cart.

In some embodiments, the system may further include an inventory management system comprising one or more inventory databases. When the automatic electronic payment transaction has been completed, the control circuit may decouple the shopping cart from the customer's online shopping cart, and remove the selected product from the one or more inventory databases or designate the selected product as sold in the one or more inventory databases. If the automatic electronic payment transaction cannot be completed, the control circuit may provide an alert and/or alternative payment instructions to the customer's portable electronic device.

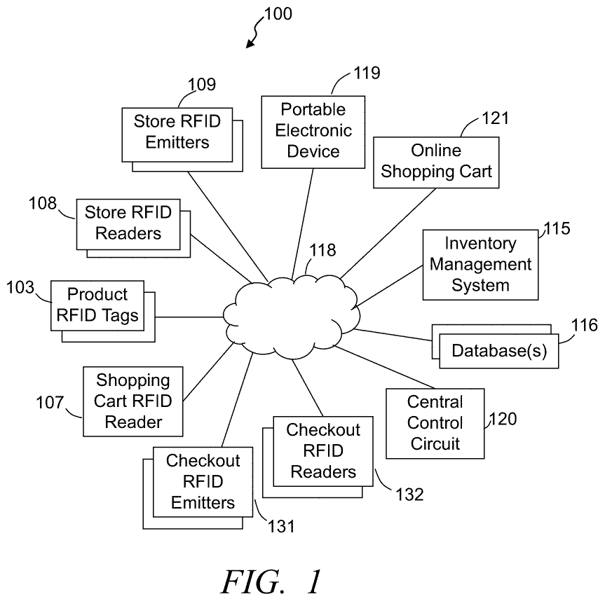

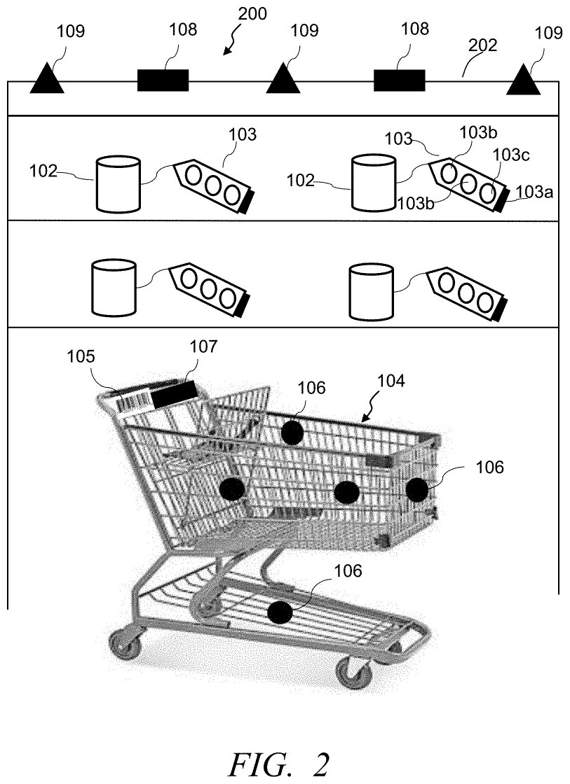

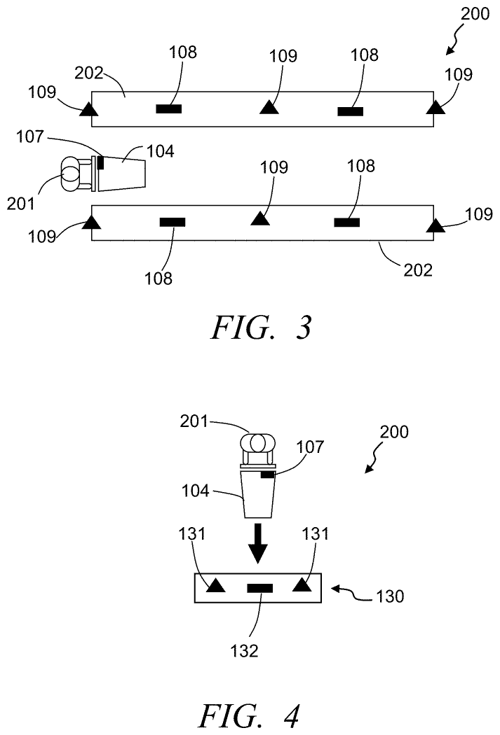

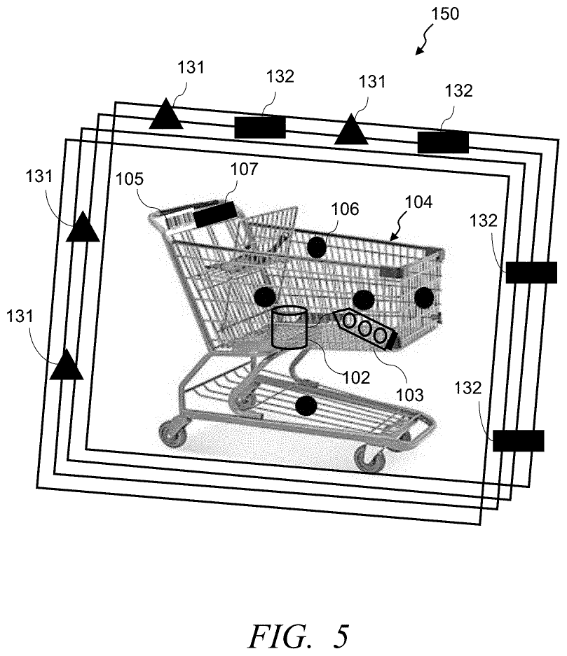

FIG. 1 illustrates a simplified block diagram of an exemplary retail store RFID-based automatic self-checkout system 100, in accordance with some embodiments. FIG. 2 illustrates a simplified view of an exemplary shopping cart 104 in front of a product support device 202 in a store 200, the shopping cart 104 containing products 102 having an active RFID tag 103 attached thereto, in accordance with some embodiments. FIG. 3 illustrates a simplified overhead view of at least a portion of an exemplary retail store 200 that includes store RFID emitters 109 and readers 108 positioned therein, in accordance with some embodiments. FIG. 4 illustrates a simplified overhead view of an automatic checkout zone 130 in a retail store 200, in accordance with some embodiments. FIG. 5 illustrates a simplified view of a shopping cart 104 in an automatic checkout zone 130 in a retail store 200, in accordance with some embodiments. in accordance with some embodiments.

Referring to FIGS. 1-5, the automatic in-store self-checkout system 100 includes products 102 for sale having active RFID tags 103 associated therewith. The active product RFID tags 103 are affixed to or incorporated into and/or into packaging of products 102 being sold from the retail store (e.g., boxed food items, canned food items, cleaning supply items, produce items, frozen food items, consumer electronic goods, health products, beauty products, and other such items), which are positioned, for example, on product support devices 202 (e.g., shelves, modulars, racks, endcaps, etc.). The product support devices 202 are positioned throughout the retail store 200.

Each of the active product RFID tags 103 includes a transmitter (not shown) and a power source such as, for example, a battery 103a, thereby enabling the active RFID tag 103 to actively broadcast or otherwise emit a signal, which can be read by a compatible RFID reader. Conversely, passive RFID tags do not have their own power source and are powered by electromagnetic energy transmitted from an RFID reader to the RFID tag's antenna. It should be understood that the use of passive product RFID tags is not contemplated in the systems, apparatuses, and methods described herein.

In some approaches, the active RFID product tags 103 described herein may continuously broadcast or otherwise emit their radio frequency signals. However, continuously emitting a radio frequency signal may quickly drain the tag's battery 103a. Thus, preferably, the active product RFID tags 103 are activated by movement, for example, when a customer 201 picks a product 102 from a product support device 202. Accordingly, each of the active product RFID tags 103 may include a 3-axis gyroscope 103b, a 3-axis accelerometer 103c, and 3-axis magnetometer 103d.

In some approaches, the active product RFID tags 103 may be configured to emit a Bluetooth signal, a Bluetooth-compatible signal, or any similar or related type of radio frequency signal. Preferably, the signal emitted by the active product RFID tags 103 is a low energy signal. For example, in some approaches, the active product RFID tags 103 may emit a Bluetooth low-energy (BLE) signal.

The signals emitted by the active RFID tags 103 affixed to the products 102 are detectable by compatible store RFID readers 108 positioned about the store 200. In some approaches, the store RFID readers 108 may be secured on or in product support devices 202, positioned on or within the floor or ceiling, or otherwise positioned to receive RFID signals from the active product RFID tags 103. The store RFID readers 108 may be communicatively coupled to a control circuit 120 and, in some approaches, the control circuit 120 may control the store RFID readers 108.

The system further includes a plurality of store RFID emitters 109 positioned at fixed locations throughout the store 200. In some approaches, the store RFID emitters 109 may be configured to emit a Bluetooth signal, a Bluetooth-compatible signal, or any similar or related radio frequency signal. Preferably, the signal emitted by the store RFID emitters 109 is a low energy signal. For example, in some approaches, the store RFID emitters 109 may emit a Bluetooth low-energy (BLE) signal. The store RFID emitters 109 may be communicatively coupled to a control circuit 120 and, in some approaches, the control circuit 120 may control the store RFID emitters 109. The store RFID emitters 109 may be secured on or in product support devices 202, positioned on or within the floor or ceiling, or otherwise positioned to emit RFID signals that are detectable by shopping carts 104 equipped with a compatible RFID reader 107 as the carts pass the store RFID emitters 109.

Each shopping cart 104 includes a unique computer readable identifier 105, which identifies the shopping cart 104 and is configured to be read by a customer's portable electronic or mobile device 119 (e.g., a smartphone, tablet, etc.). The computer readable identifier 105 may be, for example, a bar code, QR code, RFID tag, NFC tag, an image, a signal, etc., which may be read, interrogated, captured, or otherwise detected using any suitable technique. In one example, the computer readable identifier 105 may be a barcode, which the customer 201 captures using their smartphone's camera. The smartphone then communicates with the control circuit 120 to link the physical shopping cart 104 to an online shopping cart 121 associated with the customer 201.

The shopping cart 104 also includes a shopping cart RFID reader 107, which is communicatively coupled to the control circuit 120. The shopping cart RFID reader 107 is configured to read the signals emitted by the active RFID tags 103 associated with products 102, allowing the shopping cart RFID reader 107 to detect and identify products 102 that are added to and removed from the shopping cart 104 based on each product's associated active RFID tag 103. The shopping cart RFID reader 107 may also be configured to read the signals emitted by the store RFID emitters 109.

In some approaches, the shopping cart RFID reader 107 may be a Bluetooth reader or a Bluetooth compatible-reader or may be otherwise configured to read the Bluetooth or Bluetooth-compatible signals emitted by the active product RFID tags 103. Generally, since the shopping cart is mobile, it is contemplated that the shopping cart RFID reader 107 may be powered by an onboard battery (not shown).

As the shopping cart RFID reader 107 is communicatively coupled to the control circuit 120, the shopping cart RFID reader 107 is configured send messages thereto. For example, as the customer 201 pushes the shopping cart 104 through the store, the shopping cart RFID reader 107 receives signals from the store RFID emitters 109 nearby. The shopping cart RFID reader 107 sends all the received signals and/or messages to the control circuit 120, which may perform a trilateration or triangulation algorithm to determine the location of the shopping cart 104 in the store.

The shopping cart RFID reader 107 also sends to the control circuit 120 signals and/or messages related to products added to or removed from the cart. For example, when a product 102 is added to or removed from the shopping cart 104, the shopping cart RFID reader 107 detects and identifies the product 102 and communicates this information to the control circuit 120, which then electronically adds or removes the product 102 to or from the customer's online shopping cart.

In some approaches, when a customer 201 selects a product 102 from the product support device 202 and places the selected product into shopping cart 104, the active RFID tag 103 associated with the product 102 detects the movement as a first trigger. As the product 102 is placed inside shopping cart 104, the active RFID tag 103 detects the magnetic elements 106 affixed to the cart, which initiates a second trigger and prompts the active RFID tag 103 to transmit a message that is received by the shopping cart RFID reader 107 (and, in some approaches, by nearby store RFID readers 108).

The shopping cart RFID reader 107 then adds an extra marker to the received message using a unique identifier present in the active RFID tag 103 and the shopping cart RFID reader 107 sends the marked message to the control circuit 120. In some approaches, the control circuit 120 may perform the following “add” operation(s):

1. Identify a location of active product RFID tag using trilateration and a store map; and

2. Since a magnet bit is present in every message, an “attach item to shopping cart” operation may be executed as follows:
(i) Filter shopping carts based on the shopping cart's RFID reader extra marker. If more than one winner, then perform the steps below;
(ii) Select a shopping cart by finding minimum proximity between the above selected shopping carts and the product location. If more than one winner, perform the steps below;
(iii) Select a shopping cart by a maximum match of a similar movement path between shopping carts and the product. If more than one winner, perform the above steps again.
(iv) Select the winner and attach the product to the shopping cart and, in-turn attach the product to the customer's online shopping cart.

In some approaches, when a customer 201 removes a product 102 from the shopping cart 104 and places the product back onto a product support device 202, the active product RFID tag 103 detects the movement as first trigger. As the product 102 is moved away out of the shopping cart 104 and away from the magnetic elements 106 affixed thereto, the active product RFID tag 103 no longer detects the magnetic elements 106, initiating a second trigger prompting the active RFID tag 103 to transmit a message that is received by the shopping cart RFID reader 107 (and, in some approaches, by nearby store RFID readers 108). The shopping cart RFID reader 107 then adds an extra marker to the received message using a unique identifier present in the active product RFID tag 103 and sends the marked message to the control circuit 120. In some approaches, the control circuit 120 may perform the following “remove operation(s):

1. Since a magnet bit is not present in every message(s), a “detach item from the shopping cart operation will be executed as follows:
(i) The product will be removed from the previously attached shopping cart, which in-turn removes the product from the customer's online shopping cart.

As the customer 201 proceeds through the store 200 adding and/or removing products 102 from the shopping cart 104, the control circuit 120 adds and/or removes the products 102 from the customer's online shopping cart 121 as described above. The control circuit 120 may also track the shopping cart 104 throughout the store 200. For example, the control circuit 120 may determine a location of the shopping cart 104 in the store 200 based on signals received by the shopping cart RFID reader 107 from the plurality of store RFID emitters 109 positioned about the store 200, which the shopping cart RFID reader 107 transmits to the control circuit 120. The location of the shopping cart 104 may be determined by the control circuit 120 by performing a trilateration or triangulation algorithm using the locations of the signals received from the RFID emitters 109 as read by the shopping cart RFID reader 107.

In some embodiments, the control circuit 120 may also track locations of the products 102 throughout the store 200. For example, the control circuit 120 may determine a location of a product in the store 200 based on signals transmitted by active RFID product tags 103 and received by store RFID readers 108 positioned throughout the store, which are communicated to the control circuit 120. The location of the products 102 may be determined by the control circuit 120 by performing a trilateration or triangulation algorithm using the locations of the signals received from the RFID readers 108 positioned about the store and transmitted to the control circuit 120.

When the customer 201 has finished shopping, the customer 201 proceeds to, and in some embodiments simply passes through, the checkout zone 130. The checkout zone 130 is located near an exit of the store 200 and is equipped with one or more checkout RFID emitters 131. The checkout zone 130 may also be equipped with one or more checkout RFID readers 132. In some approaches, the checkout zone 130 may include one or more physical structures that delineate the checkout zone 130 from other areas of the store 200. For example, the checkout zone 130 may be delineated by an archway, an overhead structure, a partitioned lane, etc., which the customer is directed to proceed through or pass by as they exit the store 200. In such embodiments, the checkout RFID emitters 131 and checkout RFID readers 132 may be positioned or otherwise affixed to, for example, the floor, the ceiling in the checkout zone, or in or on any suitable part of the physical structure(s). In some embodiments, there may be no physical structures delineating the checkout zone 130 (although the checkout zone may be marked by signage). In such embodiments, the checkout RFID emitters 131 and checkout RFID readers 132 may be positioned or otherwise affixed to, for example, the floor, the ceiling, or on or in any suitable nearby structure near an exit of the store 200 (e.g., an adjacent point of sale kiosk, cart corral, etc.)

In some approaches, the checkout RFID emitters 131 may be configured to emit a Bluetooth signal, a Bluetooth-compatible signal, or any similar or related type of radio frequency signal. Preferably, in some approaches, the checkout RFID emitters 131 may emit a Bluetooth low-energy (BLE) signal. Preferably, the checkout RFID emitters 131 are configured to transmit signals only a short distance, to prevent checkout transactions from occurring outside of the checkout zone 130. For example, in some embodiments the checkout RFID emitters 131 are configured to transmit signals up to two meters, in some approaches up to one meter, and in some approaches less than one meter. The checkout RFID readers 132 are configured read the signals emitted by the active RFID tags 103 associated with products 102 and may be configured in a manner similar to the store RFID readers 108 described herein.

As the customer proceeds through the checkout zone 130, the shopping cart RFID reader 107 receives messages from one or more of the checkout RFID emitters 131 located in or near the checkout zone 130. The messages transmitted by checkout RFID emitters 131 may include a checkout zone indicator, which confirms the presence of the shopping cart 104 within the checkout zone 130. The shopping cart RFID reader 107 transmits the message to the control circuit 120, which communicates with the customer's online shopping cart 121 and facilitates an automatic electronic payment to pay for the products therein.

In some approaches, when the automatic electronic payment transaction has been successfully completed, the control circuit 120 electronically decouples the shopping cart 104 from the customer's online shopping cart 121 and removes the purchased products from, or designates the purchased products as sold in, one or more inventory databases 116 associated with an inventory management system 115, which are both communicatively coupled to the control circuit 120. In some approaches, if the automatic electronic payment transaction cannot be completed, the control circuit 120 may prompt an alert on the customer's portable electronic device, may cause an alert to sound in the checkout zone 130, and/or may provide alternative payment instructions to the customer's portable electronic device 119. In some approaches, the control circuit 120 may cause instructions to be transmitted to the customer to proceed to a physical checkout kiosk and/or to customer service counter.

The automatic self-checkout system 100 described herein may also be useful for preventing theft or other forms of shrink. For example, in some approaches, the active product RFID tags 103 associated with the products 102 may be configured to identify step movement of a person carrying the associated product 102 and to emit a signal when a step threshold has been exceeded. For example, using the accelerometer 103c integrated in the active RFID tag 103, the tag can sense step movement after a product 102 is removed from product support device 202. After certain number of steps is detected, the active RFID tag 103 transmits a signal that is received by one or more store RFID readers 108 positioned about the store and/or by one or more checkout RFID readers 132 positioned in or near the checkout zone 130. The step threshold may be any suitable number of steps. In some approaches, the step threshold be two steps, three steps, four steps, or even more.

When one or more store RFID readers 108 and/or checkout RFID readers 132 receives a signal from an active RFID tag 103 indicating that the step threshold has been exceeded, the RFID reader sends a signal to the control circuit 120, which may conduct a risk assessment and cause an alert if a risk threshold has been exceeded. In some approaches, the control circuit 120 may conduct a risk assessment by performing the following risk analysis:
1. Determine if the signals are being received at the checkout zone;
2. Determine if there is no magnet bit present; and
3. After several recurring samples, trigger an alarm requesting a manual security check.

As described herein, the control circuit 120 may be communicatively coupled to various components of the automatic self-checkout system 100. The control circuit 120 may be communicatively coupled to these components over one or more communication and/or computer networks 118 via wired and/or wireless signal connections. The control circuit 120 may comprise a central processing unit, a processor, a microprocessor, a memory, and the like, and may be configured to execute computer readable instructions stored on the memory. The memory may comprise volatile and/or non-volatile computer readable storage memory and have stored upon it a set of computer readable instructions which, when executed by the control circuit 120, causes the system to, among other functions, electronically link the shopping cart 104 to an online shopping cart 121 associated with the customer 201, receive and process signals from the RFID readers in the store, electronically add and remove products 102 from the customer's online shopping cart 121, initiate automatic electronic payment transactions, determine locations of the shopping carts 104 and products 102 based on signals received from the RFID readers, decouple the shopping cart 104 from the customer's online shopping cart 121, update inventory databases 116 associated with inventory management systems 115, and calculate risk assessments, as described herein.

The automatic self-checkout system 100 obviates the need for a customer or a cashier to manually scan products for purchase. Instead, products 102 are automatically added to the customer's online shopping cart 121 as the products are placed in the physical shopping cart 104 and electronic payment is automatically completed as the customer proceeds through the checkout zone 130, thereby simplifying and expediting the customer's shopping experience. The automatic self-checkout system 100 also enables the capture of information relating to time spent in the store 200 and location information for shopping carts 104 and products 102 in the store.

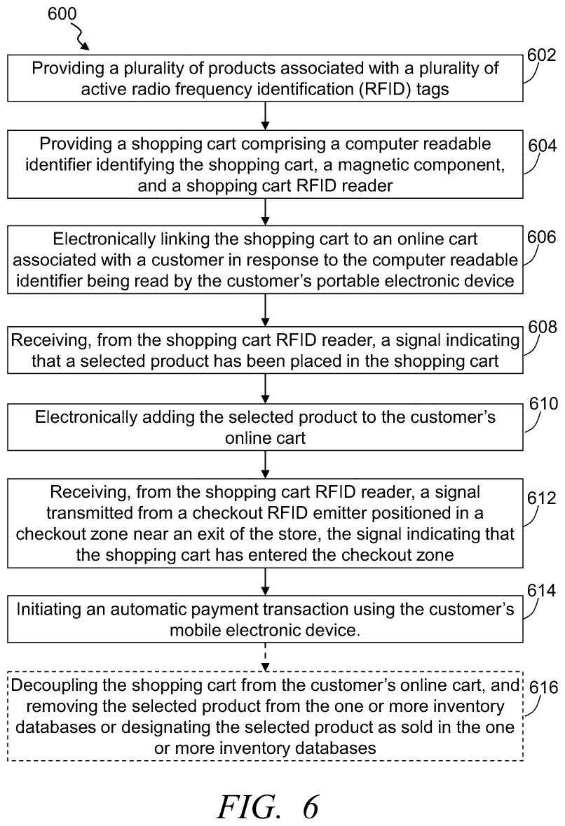

FIG. 6 illustrates a simplified flow diagram of an exemplary process 600 of performing an automatic self-checkout in a store, in accordance with some embodiments. The process 600 may be implemented using the automatic self-checkout system 100 described herein.

In step 602, a plurality of products 102 arranged in a store 202 is provided, the plurality of products 102 being associated with a plurality of active radio frequency identification (RFID) tags 103. Each active RFID tag 103 is configured to be activated by movement and comprises a battery 103a configured to power the active RFID tag. The self-powered active product RFID tags 103, which are configured to emit a signal, are distinguished from passive RFID tags, which do not emit a signal. In some approaches, the active product RFID tags 103 may be configured to emit a Bluetooth signal, a Bluetooth-compatible signal, or any similar or related type of radio frequency signal. Preferably, the signal emitted by the active product RFID tags 103 is a low energy signal. For example, in some approaches, the active product RFID tags 103 may emit a Bluetooth low-energy (BLE) signal. In some embodiments, the active RFID tags may include a 3-axis gyroscope 103b, a 3-axis accelerometer 103c, and 3-axis magnetometer 103d.

In step 604, a shopping cart 104 is provided. As described above, the shopping cart 104 comprises a computer readable identifier 105 identifying the shopping cart 104, the computer readable identifier 105 being configured to be read by a customer's portable electronic device 119. The shopping cart 104 further includes one more magnetic elements 106 affixed thereto and a shopping cart RFID reader 107 configured to detect products 102 being added to and removed from the shopping cart 104 based on each product's associated active RFID tag 103.

In step 606, the control circuit 120 electronically links the shopping cart 104 to an online shopping cart 121 associated with the customer in response to the computer readable identifier 105 being read by the customer's portable electronic device 119. The computer readable identifier 105 may be, for example, a bar code, QR code, RFID tag, NFC tag, an image, a signal, etc., which may be read, interrogated, captured, or otherwise detected using any suitable technique. For example, a customer who enters the store 200 selects a shopping cart 104 and scans or otherwise electronically reads the computer readable identifier 105 associated with the cart with their portable electronic device 119. The scan data is communicated to the control circuit 120, which prompts the control circuit 120 to electronically link the shopping cart 104 to the customer's online shopping cart 121.

In step 608, as the customer proceeds to shop and places products 102 in the shopping cart 104, the shopping cart RFID reader 107 detects and/or identifies each selected product 102 based on the product's associated active RFID tag 103, which the shopping cart RFID reader 107 communicates to the control circuit 120. In other words, the control circuit 120 receives from the shopping cart RFID reader 107 a signal indicating that a selected product 102 has been placed in the shopping cart 104.

In step 610, the control circuit 120 electronically adds the selected product 102 to the customer's online shopping cart 121 in response to receiving the signal from the shopping cart RFID reader 107 indicating that the selected product 102 has been placed in the shopping cart 104.

As described above, in some approaches, when a customer 201 selects a product 102 from the product support device 202 and places the selected product into shopping cart 104, the active RFID tag 103 associated with the product 102 detects the movement as a first trigger. As the product 102 is placed inside shopping cart 104, the active RFID tag 103 detects the magnetic elements 106 affixed to the cart, which initiates a second trigger and prompts the active RFID tag 103 to transmit a message that is received by the shopping cart RFID reader 107. The shopping cart RFID reader 107 then adds an extra marker to the received message using a unique identifier present in the active RFID tag 103 and the shopping cart RFID reader 107 sends the marked message to the control circuit 120. In some approaches, the control circuit may perform the “add” operation(s) described above.

In some approaches, when a customer 201 removes a product 102 from the shopping cart 104 and places the product back onto a product support device 202, the active product RFID tag 103 detects the movement as first trigger. As the product 102 is moved away out of the shopping cart 104 and away from the magnetic elements 106 affixed thereto, the active product RFID tag 103 no longer detects the magnetic elements 106, initiating a second trigger prompting the active RFID tag 103 to transmit a message that is received by the shopping cart RFID reader 107. The shopping cart RFID reader 107 then adds an extra marker to the received message using a unique identifier present in the active product RFID tag 103 and sends the marked message to the control circuit 120. In some approaches, the control circuit may perform the “remove” operation(s) described above.

When the customer 201 has finished shopping, the customer 201 proceeds to, and in some embodiments simply passes through, the checkout zone 130 located near an exit of the store 200. As discussed above, in some embodiments the checkout zone 130 may include one or more physical structures that delineate the checkout zone 130 from other areas of the store 200 or the checkout zone 130, while in other embodiments there may be no physical structures delineating the checkout zone 130 (although the checkout zone may be marked by signage).

The checkout zone 130 is equipped with one or more checkout RFID emitters and, in some approaches, one or more checkout RFID readers 132, which may be positioned or otherwise affixed to, for example, the floor, the ceiling in the checkout zone, or in or on any suitable part of a physical structure(s), depending on the configuration of the checkout zone 130. In some approaches, the checkout RFID emitters 131 may be configured to emit a Bluetooth signal, a Bluetooth-compatible signal, or any similar or related type of radio frequency signal. Preferably, in some approaches, the checkout RFID emitters 131 may emit a Bluetooth low-energy (BLE) signal. Preferably, the checkout RFID emitters 131 are configured to transmit signals only a short distance, to prevent checkout transactions from occurring outside of the checkout zone 130. For example, in some embodiments the checkout RFID emitters 131 are configured to transmit signals up to two meters, in some approaches up to one meter, and in some approaches less than one meter. The checkout RFID readers 132 are configured read the signals emitted by the active RFID tags 103 associated with products 102 and may be configured in a manner similar to the store RFID readers 108 described herein.

In step 612, the control circuit 120 receives from the shopping cart RFID reader 107 a signal transmitted from a checkout RFID emitter 131 indicating that the shopping cart 104 has entered the checkout zone 130. In some approaches, as the customer proceeds through the checkout zone 130, the shopping cart RFID reader 107 receives messages from one or more of the checkout RFID emitters 131 located in or near the checkout zone 130. The messages transmitted by checkout RFID emitters 131 may include a checkout zone indicator, which confirms the presence of the shopping cart 104 within the checkout zone 130. The shopping cart RFID reader 107 then transmits the messages to the

In step 614, the control circuit 120 initiates an automatic payment transaction using the customer's portable electronic device 119. For example, when the shopping cart RFID reader 107 transmits the message to the control circuit 120 the presence of the shopping cart 104 within the checkout zone 130, the control circuit 120 communicates with the customer's online shopping cart 121 and facilitates an automatic electronic payment to pay for the products in the cart.

In optional step 614, in response to the payment transaction being completed, the control circuit 120 decouples the shopping cart from the customer's online shopping cart 121, and removes the selected products 102 from, or designates the selected product as sold in, the one or more inventory databases 116 associated with inventory management system 115, which are both communicatively coupled to the control circuit 120. In some approaches, if the automatic electronic payment transaction cannot be completed, the control circuit 120 may prompt an alert on the customer's portable electronic device, may cause an alert to sound in the checkout zone 130, and/or may provide alternative payment instructions to the customer's portable electronic device 119. In some approaches, the control circuit 120 may cause instructions to be transmitted to the customer to proceed to a physical checkout kiosk and/or to customer service counter.

As discussed above, as the customer 201 proceeds through the store 200 adding and/or removing products 102 from the shopping cart 104, the control circuit 120 adds and/or removes the products 102 from the customer's online shopping cart 121. In some approaches, the control circuit 120 may also track the shopping cart 104 throughout the store 200. For example, the control circuit 120 may determine a location of the shopping cart 104 in the store 200 based on signals received by the shopping cart RFID reader 107 from the plurality of store RFID emitters 109 positioned about the store 200, which the shopping cart RFID reader 107 transmits to the control circuit 120. The location of the shopping cart 104 may be determined by the control circuit 120 by performing a trilateration or triangulation algorithm using the locations of the signals received from the RFID emitters 109 as read by the shopping cart RFID reader 107.

In some embodiments, the control circuit 120 may also track locations of the products 102 throughout the store 200. For example, the control circuit 120 may determine a location of a product in the store 200 based on signals transmitted by active RFID product tags 103 and received by store RFID readers 108 positioned throughout the store, which are communicated to the control circuit 120. The location of the products 102 may be determined by the control circuit 120 by performing a trilateration or triangulation algorithm using the locations of the signals received from the RFID readers 108 positioned about the store and transmitted to the control circuit 120.

Additionally, since the active product RFID tags 103 include an integrated accelerometer 103c as described above, the tags may be used to prevent theft or other forms of shrink. For example, using the accelerometer 103c, the active RFID tag 103 may be configured to sense step movement after a product 102 is removed from product support device 202. When a step threshold has been reached or exceeded, the active RFID tag 103 may transmit a signal that is received by one or more store RFID readers 108 positioned about the store and/or by one or more checkout RFID readers 132 positioned in or near the checkout zone 130. The step threshold may be any number of steps. In some approaches, the step threshold be two steps, three steps, four steps, or even more. When one or more of the store RFID readers 108 and/or the checkout RFID readers 132 receives the signal from an active RFID tag 103 indicating that the step threshold has been exceeded, the RFID reader sends the signal to the control circuit 120, which may conduct a risk analysis as described above and may cause an alert if a risk threshold has been exceeded.

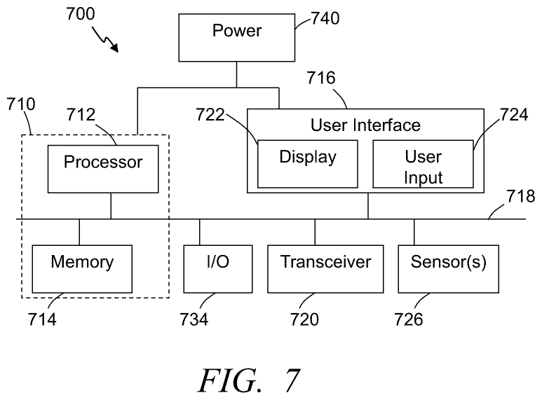

Further, the circuits, circuitry, systems, devices, processes, methods, techniques, functionality, services, servers, sources and the like described herein may be utilized, implemented and/or run on many different types of devices and/or systems. FIG. 7 illustrates an exemplary system 700 that may be used for implementing any of the components, circuits, circuitry, systems, functionality, apparatuses, processes, or devices of the automatic in-store self-checkout system 100, the shopping cart RFID reader 107, the store RFID readers 108, the store RFID emitters 109, the checkout RFID emitters 131, the checkout RFID readers 132, the inventory management system 115, the inventory database(s) 116, the control circuit 120, and/or other above or below mentioned systems or devices, or parts of such circuits, circuitry, functionality, systems, apparatuses, processes, or devices. However, the use of the system 700 or any portion thereof is certainly not required.

By way of example, the system 700 may comprise a control circuit or processor module 712, memory 714, and one or more communication links, paths, buses or the like 718. Some embodiments may include one or more user interfaces 716, and/or one or more internal and/or external power sources or supplies 740. The control circuit 712 (which may form all or part of control circuit 120) can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 712 can be part of control circuitry and/or a control system 710, which may be implemented through one or more processors with access to one or more memory 714 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 700 may be used to implement one or more of the above or below, or parts of, components, circuits, systems, processes and the like.

The user interface 716 can allow a user to interact with the system 700 and receive information through the system. In some instances, the user interface 716 includes a display 722 and/or one or more user inputs 724, such as buttons, touch screen, track ball, keyboard, mouse, etc., which can be part of or wired or wirelessly coupled with the system 700. Typically, the system 700 further includes one or more communication interfaces, ports, transceivers 720 and the like allowing the system 700 to communicate over a communication bus, a distributed computer and/or communication network 118 (e.g., a local area network (LAN), the Internet, wide area network (WAN), etc.), communication link 718, other networks or communication channels with other devices and/or other such communications or combination of two or more of such communication methods. Further the transceiver 720 can be configured for wired, wireless, optical, fiber optical cable, satellite, or other such communication configurations or combinations of two or more of such communications. Some embodiments include one or more input/output (I/O) ports 734 that allow one or more devices to couple with the system 700. The I/O ports can be substantially any relevant port or combinations of ports, such as but not limited to USB, Ethernet, or other such ports. The I/O interface 734 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 726 to provide information to the system and/or sensor information that is communicated to another component, such as the central control circuit, the inventory management system 115, the various RFID readers, etc. The sensors can include substantially any relevant sensor, such as distance measurement sensors (e.g., optical units, sound/ultrasound units, etc.), optical based scanning sensors to sense and read optical patterns (e.g., bar codes), and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 700 comprises an example of a control and/or processor-based system with the control circuit 712. Again, the control circuit 712 can be implemented through one or more processors, controllers, central processing units, logic, software and the like. Further, in some implementations the control circuit 712 may provide multiprocessor functionality.

The memory 714, which can be accessed by the control circuit 712, typically includes one or more processor readable and/or computer readable media accessed by at least the control circuit 712, and can include volatile and/or nonvolatile media, such as RAM, ROM, EEPROM, flash memory and/or other memory technology. Further, the memory 714 is shown as internal to the control system 710; however, the memory 714 can be internal, external or a combination of internal and external memory. Similarly, some or all of the memory 714 can be internal, external or a combination of internal and external memory of the control circuit 712. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 118. The memory 714 can store code, software, executables, scripts, data, content, lists, programming, programs, log or history data, user information, customer information, product information, and the like. While FIG. 7 illustrates the various components being coupled together via a bus, it is understood that the various components may actually be coupled to the control circuit and/or one or more other components directly.

In some embodiments, automatic in-store self-checkout systems are provided and corresponding methods performed by the systems. An automatic in-store self-checkout system, in some embodiments, comprises: a plurality of products arranged in a store, the plurality of products associated with a plurality of active radio frequency identification (RFID) tags, wherein each active RFID tag is configured to be activated by movement and comprises a battery configured to power the active RFID tag; a shopping cart comprising: a computer readable identifier identifying the shopping cart and configured to be read by a customer's portable electronic device; a magnetic element; and a shopping cart RFID reader configured to detect products being added to and removed from the shopping cart based on each product's associated active RFID tag; a plurality of store RFID readers positioned about the store, wherein the plurality of store RFID readers are configured to receive signals from the plurality of active RFID tags associated with the plurality of products; a plurality of store RFID emitters positioned about the store; a checkout RFID emitter positioned in a checkout zone near an exit of the store; and a control circuit communicatively coupled to the shopping cart RFID reader, the plurality of store RFID readers, the control circuit configured to: electronically link the shopping cart to an online shopping cart associated with the customer when the computer readable identifier is read by the customer's portable electronic device; receive, from the shopping cart RFID reader, a signal indicating that a selected product has been placed in the shopping cart; electronically add the selected product to the customer's online shopping cart; receive, from the shopping cart RFID reader, a signal transmitted from the checkout RFID emitter indicating that the shopping cart has entered the checkout zone; and facilitate an automatic electronic payment transaction.

Some embodiments provide methods of performing an automatic self-checkout in a store, comprising: providing a plurality of products arranged in a store, the plurality of products associated with a plurality of active radio frequency identification (RFID) tags, wherein each active RFID tag is configured to be activated by movement and comprises a battery configured to power the active RFID tag; providing a shopping cart comprising: a computer readable identifier identifying the shopping cart and configured to be read by a customer's portable electronic device; a magnetic element; and a shopping cart RFID reader configured to detect products being added to and removed from the shopping cart based on each product's associated active RFID tag; electronically linking the shopping cart to an online shopping cart associated with the customer in response to the computer readable identifier being read by the customer's portable electronic device; receiving, from the shopping cart RFID reader, a signal indicating that a selected product has been placed in the shopping cart; electronically adding the selected product to the customer's online shopping cart; receiving, from the shopping cart RFID reader, a signal transmitted from a checkout RFID emitter positioned in a checkout zone near an exit of the store, the signal indicating that the shopping cart has entered the checkout zone; and initiating an automatic payment transaction using the customer's portable electronic device.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An automatic in-store self-checkout system, the system comprising:
a plurality of products arranged in a store, the plurality of products associated with a plurality of active radio frequency identification (RFID) tags, wherein each active RFID tag is configured to be activated by movement and comprises a battery configured to power the active RFID tag;
a shopping cart comprising:
a computer readable identifier identifying the shopping cart and configured to be read by a customer's portable electronic device;
a magnetic element; and
a shopping cart RFID reader configured to detect products being added to and removed from the shopping cart based on each product's associated active RFID tag;
a plurality of store RFID readers positioned about the store, wherein the plurality of store RFID readers are configured to receive signals from the plurality of active RFID tags associated with the plurality of products;
a plurality of store RFID emitters positioned about the store;
a checkout RFID emitter positioned in a checkout zone near an exit of the store; and
a control circuit communicatively coupled to the shopping cart RFID reader, the plurality of store RFID readers, the control circuit configured to:
electronically link the shopping cart to an online cart associated with the customer when the computer readable identifier is read by the customer's portable electronic device;
receive, from the shopping cart RFID reader, a signal indicating that a selected product has been placed in the shopping cart;
electronically add the selected product to the customer's online cart;
receive, from the shopping cart RFID reader, a signal transmitted from the checkout RFID emitter indicating that the shopping cart has entered the checkout zone; and
facilitate an automatic electronic payment transaction.

2. The system of claim 1, wherein the plurality of active RFID tags are configured to communicate using a Bluetooth-compatible low energy signal.

3. The system of claim 1, further comprising an inventory management system comprising one or more inventory databases, wherein when the automatic electronic payment transaction has been completed, the control circuit is configured to decouple the shopping cart from the customer's online cart, and remove the selected product from the one or more inventory databases or designate the selected product as sold in the one or more inventory databases.

4. The system of claim 1, wherein the control circuit is further configured to determine a location of the shopping cart in the store based on signals received by the shopping cart RFID reader from the plurality of store RFID emitters positioned about the store, which the shopping cart RFID reader transmits to the control circuit.

5. The system of claim 1, wherein the control circuit is further configured to determine a location of the active RFID tag associated with the selected product based on signals from the active RFID tag received by the plurality of store RFID readers, which the plurality of store RFID readers transmit to the control circuit.

6. The system of claim 1, wherein each of the plurality of active RFID tags further comprises a 3-axis gyroscope, a 3-axis accelerometer, and 3-axis magnetometer.

7. The system of claim 6, wherein when the selected product is moved from its location and placed into the shopping cart,
movement detected by the active RFID tag associated with the selected product activates the active RFID tag;
the active RFID tag detects the shopping cart's magnetic element and causes the active RFID tag to transmit a first signal, which is received by the shopping cart RFID reader; and
the shopping cart RFID reader adds to the first signal a marker associated with the shopping cart RFID reader and transmits the marked first signal to the control circuit indicating that the selected product has been placed in the shopping cart, causing the control circuit to electronically add the selected product to the customer's online cart.

8. The system of claim 6, when the selected product is removed from the shopping cart, the active RFID tag associated with the selected product detects the movement, which reactivates the RFID tag, and when the active RFID tag no longer detects the shopping cart's magnetic element, the active RFID tag transmits a second signal, which is received by the shopping cart RFID reader, and
the shopping cart RFID reader adds to the second signal the marker associated with the shopping cart RFID reader and transmits the marked second signal to the control circuit indicating that the selected product has been removed from the shopping cart, causing the control circuit to electronically remove the selected product to the customer's online cart.

9. The system of claim 1, wherein if the automatic electronic payment transaction cannot be completed, the control circuit is configured to provide an alert and/or alternative payment instructions to the customer's portable electronic device.

10. The system of claim 1, wherein each of the plurality of active RFID tags is further configured to identify step movement and to emit a signal when a step threshold has been exceeded, and
when one or more of the plurality of store RFID readers receives a signal from one of the plurality of active RFID tags indicating that the step threshold has been exceeded, the signal is transmitted to the control circuit and the control circuit conducts a risk assessment and causes an alert if a risk threshold has been exceeded.

11. A method of performing an automatic self-checkout in a store, the method comprising:
providing a plurality of products arranged in a store, the plurality of products associated with a plurality of active radio frequency identification (RFID) tags, wherein each active RFID tag is configured to be activated by movement and comprises a battery configured to power the active RFID tag;
providing a shopping cart comprising: a computer readable identifier identifying the shopping cart and configured to be read by a customer's portable electronic device; a magnetic element; and a shopping cart RFID reader configured to detect products being added to and removed from the shopping cart based on each product's associated active RFID tag;
electronically linking the shopping cart to an online cart associated with the customer in response to the computer readable identifier being read by the customer's portable electronic device;
receiving, from the shopping cart RFID reader, a signal indicating that a selected product has been placed in the shopping cart;
electronically adding the selected product to the customer's online cart;
receiving, from the shopping cart RFID reader, a signal transmitted from a checkout RFID emitter positioned in a checkout zone near an exit of the store, the signal indicating that the shopping cart has entered the checkout zone; and
initiating an automatic payment transaction using the customer's portable electronic device.

12. The method of claim 11, wherein the plurality of active RFID tags are configured to communicate using a Bluetooth-compatible low energy signal.

13. The method of claim 11, further comprising, in response to the payment transaction being completed, decoupling the shopping cart from the customer's online cart, and removing the selected product from the one or more inventory databases or designating the selected product as sold in the one or more inventory databases.

14. The method of claim 11, further comprising determining a location of the shopping cart in the store based on signals received by the shopping cart RFID reader from a plurality of store RFID emitters positioned about the store.

15. The method of claim 11, further comprising determining a location of the active RFID tag associated with the selected product based on signals transmitted from the active RFID tag and received by a plurality of store RFID readers positioned about the store.

16. The method of claim 11, wherein each of the plurality of active RFID tags further comprises a 3-axis gyroscope, a 3-axis accelerometer, and 3-axis magnetometer.

17. The method of claim 16, wherein when the selected product is moved from its location and placed into the shopping cart, movement detected by the active RFID tag associated with the selected product activates the active RFID tag;
the active RFID tag detects the shopping cart's magnetic element and causes the active RFID tag to transmit a first signal, which is received by the shopping cart RFID reader; and
the shopping cart RFID reader adds to the first signal a marker associated with the shopping cart RFID reader and transmits the marked first signal to a control circuit indicating that the selected product has been placed in the shopping cart, causing the control circuit to electronically add the selected product to the customer's online cart.

18. The method of claim 16, wherein when the selected product is removed from the shopping cart, the active RFID tag associated with the selected product detects the movement, which reactivates the active RFID tag, and when the active RFID tag no longer detects the shopping cart's magnetic element, the active RFID tag transmits a second signal, which is received by the shopping cart RFID reader, and
the shopping cart RFID reader adds to the second signal the marker associated with the shopping cart RFID reader and transmits the marked second signal to a control circuit indicating that the selected product has been removed from the shopping cart, causing the control circuit to electronically remove the selected product to the customer's online cart.

19. The method of claim 11, wherein if the automatic electronic payment transaction cannot be completed, the control circuit is configured to provide an alert and/or alternative payment instructions to the customer's portable electronic device.

20. The method of claim 11, wherein each of the plurality of active RFID tags is further configured to identify step movement and to emit a signal when a step threshold has been exceeded, and
when one or more of a plurality of store RFID readers positioned about the store receives a signal from one of the plurality of active RFID tags indicating that the step threshold has been exceeded, the signal is transmitted to a control circuit and the control circuit conducts a risk assessment and causes an alert if a risk threshold has been exceeded.
